(19) United States
(12) Patent Application Publication
(10) Pub. No.: US 2004/0217338 A1
(43) Pub. Date: Nov. 4, 2004

(54) Device and method for leveling recreational vehicles

(76) Inventor: Guy A. Abrahamson, Sandy, UT (US)

Correspondence Address: David R. McKinney, THORPE NORTH & WESTERN, LLP, P.O. Box 1219, Sandy, UT, 84091-1219, US

(21) Appl. No.: 10/837,141

(22) Filed: Apr. 30, 2004

Related U.S. Application Data
(60) Provisional application No. 60/466,941, filed on Apr. 30, 2003.

(51) Int. Cl. B60R 15/00

(52) U.S. Cl. 254/93 H

(57) ABSTRACT

A device for lifting a recreational vehicle to a desired elevation for leveling purposes includes a flexible, pressure resistant enclosure having an upper side for contacting a tire of the recreational vehicle, a lower side for being positioned at a ground surface, and an air valve for supplying and releasing air to the enclosure. The enclosure is configured to be disposed between the ground and a tire of the recreational vehicle on a low side of the vehicle, and be inflated with pressurized air so as to lift the tire and level the vehicle.

This application claims priority from U.S. Provisional Patent Application Ser. No. 60/466,941, filed on Apr. 30, 2003 and entitled DEVICE AND METHOD FOR LEVELING RECREATIONAL VEHICLES.

### BACKGROUND OF THE INVENTION

1. Field of the Invention

The present invention relates generally to recreational vehicles. More particularly, the present invention relates to a device for leveling a recreational vehicle on sloped ground.

2. Related Art

Motor homes, travel trailers, campers, and other recreational vehicles are becoming increasingly popular. These vehicles enable their owners to enjoy comfortable accommodations when traveling away from home, whether in remote rural areas, or in an urban setting. They can provide comfort in an otherwise primitive setting, and can provide private, low cost accommodations in areas that might otherwise be costly or not have accommodations available at all.

One challenge faced by RV owners is leveling their motor home, camper, or trailer. In rural locations, such as a wilderness campsite, it can be very difficult to find a level patch of ground. However, even in improved areas, such as an RV park with paved roads and improved RV pads, few sites are truly level. When the vehicle is not level, this can create a variety of problems. Sleeping accommodations are less comfortable. Tabletops become sloped and difficult to use. Cooking is difficult on a sloped range. Everything becomes more complicated and uncomfortable when the vehicle is tilted.

The task of leveling an RV can be tedious and inexact. Perhaps the most common method is to park the RV with the wheels on one side atop boards or blocks that are placed on the ground in line with the tires on the low side of the vehicle. These may be blocks of wood, masonry, or any other suitably strong material. Specially-made interlocking blocks and ramps are also available for this purpose. By placing a wheel or wheels of one side of the RV on the blocks or a ramp, the low side of the vehicle can be raised to try to make it level. Once the vehicle is raised as desired, stabilizer jacks are usually lowered at the extreme corners of the vehicle to contact the ground and help stabilize the vehicle for use at the site.

Unfortunately, this method of leveling an RV can be awkward and unsatisfactory. First, it can be difficult to accurately place the lift blocks or ramps on the ground and then push or pull the vehicle onto them. A block of wood or a ramp may deflect out from under a tire as the tire attempts to mount it, especially blocks that are stacked on other blocks, and it may be difficult to negotiate a trailer or motor home to track onto a stack of blocks. Additionally, because a stack of blocks or boards necessarily involves a plurality of units of discrete sizes, the adjustability is limited to increments of the size of the blocks. Consequently, it can be difficult to get an RV truly level. Instead, it usually ends up slightly tilted one way or the other. Moreover, the entire operation of getting the vehicle onto a ramp or stack of blocks of the right height may require substantial trial and error and a significant amount of time.

In answer to this problem, some recreational vehicles are provided with on-board leveling devices. Some, particularly high cost motor homes, have power leveling systems with hydraulic jacks that extend from the vehicle frame to lift, level, and stabilize it. Additionally, some recreational vehicles have been built with hydraulic suspension systems that can adjust the lift of the vehicle relative to its wheels to level it. However, these systems are complicated, expensive, and not very common. Most RV owners continue to struggle with leveling their vehicle for want of a simple, low-cost system for doing so.

### SUMMARY OF THE INVENTION

It has been recognized that it would be advantageous to develop a simple, low-cost system for leveling a recreational vehicle.

The invention advantageously provides a device for lifting a recreational vehicle to a desired elevation for leveling purposes. The device includes a flexible, pressure resistant enclosure having an upper side for contacting a tire, and a lower side for being positioned at a ground surface, and configured to contain an interior pressure of up to 50 psi. The enclosure includes an air valve for supplying and releasing air to the enclosure, and is configured to support wheel contact at its upper surface to facilitate raising and lowering the tire of the recreational vehicle.

In accordance with a more detailed aspect of the present invention, the pressure resistant enclosure is configured as a flexible tubular member with opposing ends that are sealed, having a biased configuration that is substantially flat when not inflated. In one particular embodiment, the pressure resistant enclosure has a size less than approximately 2 feet by 3 feet.

In accordance with another aspect thereof, the present invention provides a method for leveling a recreational vehicle parked on a sloped site. The method includes the steps of (a) identifying a wheel of the recreational vehicle on a low side of the vehicle; (b) placing an uninflated air bag on the ground near a tire of the vehicle on the low side; (c) maneuvering the tire of the recreational vehicle to a position atop the uninflated air bag; and (d) inflating the air bag so as to raise the low side of the vehicle.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a plan view of one embodiment of a device for leveling a recreational vehicle in accordance with the present invention.

FIG. 2a is a side view of the device of FIG. 1 in an uninflated condition.

FIG. 2b is a side view of the device of FIG. 1 in an inflated condition.

FIG. 3a is a cross-sectional view of a recreational vehicle parked on a sloping surface with an uninflated leveling bag disposed under the wheel on the low side.

FIG. 3b is a cross-sectional view of a recreational vehicle parked on a sloping surface with an inflated leveling bag disposed under the wheel on the low side, so as to level the vehicle.

FIG. 4 is a perspective view of an alternative embodiment of a load-leveling device in accordance with the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

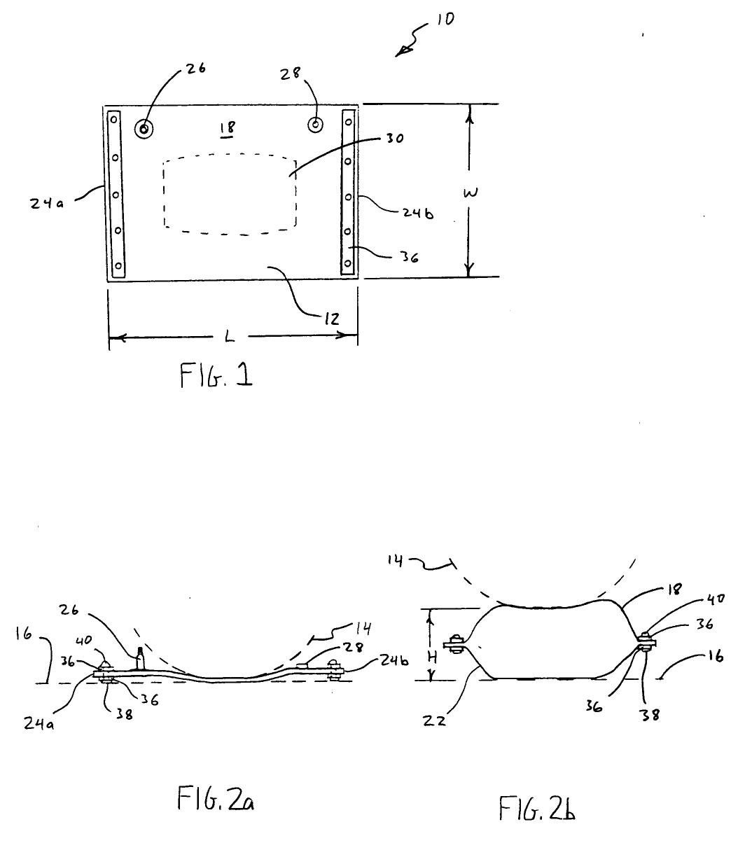

With reference to FIGS. 1 and 2, the invention provides a device for lifting a recreational vehicle to a desired elevation for leveling purposes. The device 10 essentially comprises an air bag configured to be placed under a tire of a recreational vehicle and inflated to lift the tire. The invention generally comprises a flexible, pressure resistant enclosure 12 having a biased configuration that is substantially flat when uninflated (as shown in FIG. 2a), but which enlarges when inflated so as to raise a vehicle tire 14 off the ground 16 some distance H, as shown in FIG. 2b. The enclosure has an upper side 18 configured for contacting a tire 14 of a recreational vehicle 20, and a lower side 22 configured to be placed on the surface of the ground 16. The enclosure has opposing ends 24a, 24b, that are sealed sufficiently to contain the interior pressure. The device further includes an air valve 26 coupled to the enclosure for supplying and releasing air to the enclosure. The device may also include a pressure relief valve 28 to prevent it from being overinflated. The air valve is similar to air valves used on automobile tires. The pressure relief valve could be incorporated as part of the air valve, or could be a separate unit, as shown.

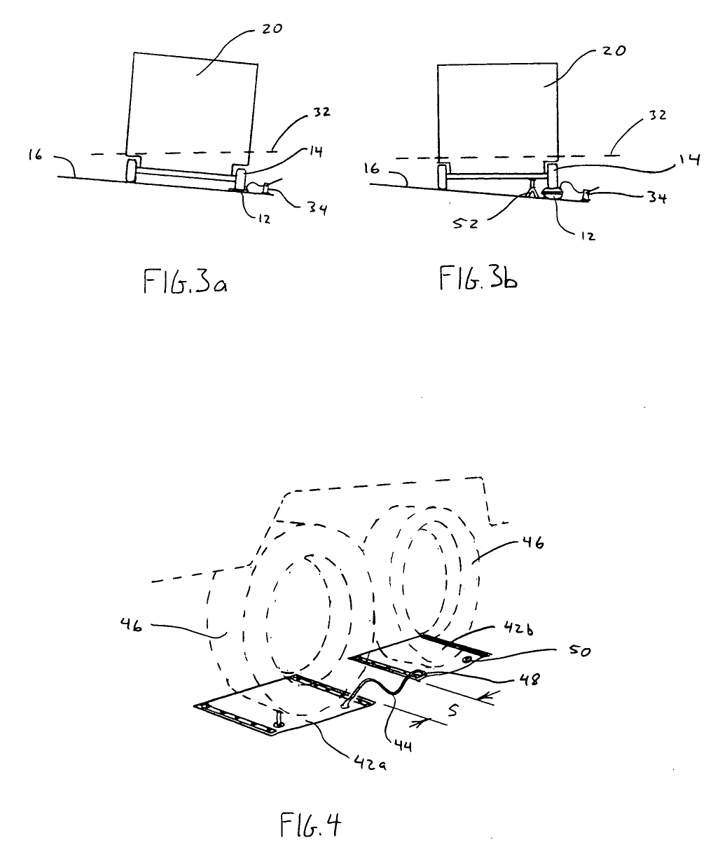

The sealed opposing ends 24 and the enclosure 12 are structured to support wheel contact at the surface of the upper side 18 without damaging the pressure resistant enclosure. Referring to FIGS. 3a and 3b, to level a recreational vehicle 20, a user first places one or more uninflated leveling devices 10 on the ground 16 adjacent to the tire(s) 14 on the low side of the vehicle. The user then moves the vehicle so that the tire(s) is/are sitting approximately in the middle region (30 in FIG. 1) of the top side of the enclosure(s). The user then inflates the enclosure(s), so as to lift the low side of the vehicle the desired amount, so as to align the vehicle with the horizontal, represented by a dashed line 32 in FIGS. 3a and 3b. Inflation of the enclosure(s) can be accomplished using a pump 34, which can be a hand or foot pump, or an air compressor, or any other suitable device for providing pressurized air through a hose to the air valve 26.

In one embodiment, the enclosure 12 comprises a section of high pressure nylon hose, such as SF-50 high strength discharge hose made by Sun-Flow, Inc. This hose has a maximum pressure rating of 115 psi, and a burst strength of about 350 psi. While the device of the invention could be configured to function with a wide range of pressures, the embodiments shown are intended for a maximum pressure of up to 50 psi. This maximum pressure can be ensured by use of the pressure relief valve 28. The cut ends 24 of the hose are sealed with a coating of black silicone adhesive disposed between the inner surfaces, and mechanically clamped together by means of aluminum bars 36 that are placed on each side (top and bottom) of the enclosure, and connected together with bolts 38 and cap nuts 40.

It will be apparent that the enclosure 12 can be configured in other ways. For example, the cut ends of the hose section could be sealed together by PVC welding, or other comparable methods, thus avoiding the need for the clamp bars 36. Alternatively, the enclosure could be fabricated with different materials and by other methods altogether. For example, the enclosure could be formed using materials and processes well known in the tire manufacturing industry, so as to produce a substantially complete enclosure—an integral, flexible, inflatable pressure vessel—without the need for sealing any openings, except perhaps those for valves, etc. Any materials and methods that will produce an enclosure having the size, shape, flexibility and strength requirements for the use disclosed herein will be suitable for the present invention.

The size of the enclosure(s) 12 can vary. It will be apparent that the device needs to be large enough that it can provide an adequately large support surface for the vehicle tire 14 when inflated. Additionally, it will be apparent that the maximum lift distance that can be provided by the device is dependent upon the length and width of the device. However, if the device is too large it can be unwieldy and require too much storage space. Referring to FIG. 1, the device 10 preferably has a width W that is less than approximately 2 feet, and a length L that is less than about 3 feet. In one embodiment, the inventor has used a section of 8 inch diameter hose having a length L of about 22 inches, and which provides a width W of about 13 inches when flattened out.

Advantageously, because the air pressure in the enclosure 12 can be varied across a wide range, the magnitude of lifting of the vehicle tires can be adjusted to provide a truly level configuration. Those familiar with the principles of operations of pneumatic vehicle tires will recognize that the surface area of a tire in contact with the ground is directly proportional to the load on that tire and the air pressure inside. If a tire is inflated to 30 psi and supports a load of 3000 pounds, then 100 square inches of that tire will be in contact with the ground. If the pressure is increased or the load is reduced, a smaller area of the tire will be in contact with the ground, and vice versa. This accounts for the lifting action of tires when they are inflated. As the pressure increases in the tire, the region of the tire adjacent to the ground will expand so that the contact area remains proportional to the load and the pressure. This lifts the vehicle.

The air bags of the current invention operate in the same way. As the pressure in the enclosure 12 is increased, the enclosure expands and lifts the vehicle. Because the weight of the RV does not change, the shape of the air bag will change with changing pressure to keep the ground contact area proportional. Consequently, a user can make slight adjustments in the pressure and thereby make slight adjustments in the lift provided by an air bag so that the vehicle becomes truly level. The 13″ by 22″ air bag configuration depicted in FIGS. 1 and 2 allows a maximum lift distance H of about 5 inches when inflated to around 40 psi.

In an alternative embodiment, shown in FIG. 4, the invention can comprise a pair of enclosures 42a, 42b interconnected by an air hose 44, so that two bags can be simultaneously inflated. Because the air hose is flexible, the distance S between the air bags can be adjusted to conform to the spacing of adjacent tandem wheels 46 in the wheel set. The inlet 48 of the hose to the second air bag could include its own one-way valve, and the bag could include a separate pressure relief valve 50 so that the pressure in the bags can be independently varied.

It will be apparent that an RV site may not have a slope that is merely transverse to the width of the vehicle, but is at an angle relative to the length of the vehicle. The inventor has found that the present invention can accommodate such a situation, particularly with RVs having tandem wheels 46, as depicted in FIG. 4, and also with motor homes having both front and rear wheels. In such a situation, the pressure in the air bags disposed under adjacent tandem wheels (or under the front and rear wheels on one side of a motor home) can be varied so as to produce a desired degree of lengthwise tilt in the vehicle, in addition to any needed transverse tilt. Specifically, for a site that tilts forward, the forward air bag 42a can be provided with a higher pressure, and hence provide more lift, than the rearward air bag 42b, to compensate for the forward tilt of the site. This would be in addition to the inflation of the bags provided to compensate for side-to-side tilt of the site.

The system of the present invention also anticipates the possibility that an air bag could leak or deflate. If an air bag rapidly deflates while supporting an RV, the sudden drop could cause the vehicle to become unstable. On the other hand, if an airbag slowly deflates, this can gradually impose excessive stress on stabilizer jacks, which are not intended to support the entire weight of the vehicle. As shown in FIG. 3b, to provide for these situations, a height-adjustable jack stand 52 or other substantially rigid support can be placed under a portion of the RV frame or axle near the air bag to provide backup support.

The inventor has also found that in some cases the deflation of one air bag can be automatically accommodated by rotation of a tandem axle set. Where tandem axle vehicles are lifted using this invention (as shown in FIG. 4), the deflation of a single air bag may cause one wheel of the tandem set to rotate down to contact the ground, while the other remains lifted on its inflated air bag.

By way of example, and without limitation, the invention can be described as a device for lifting a recreational vehicle to a desired elevation for leveling purposes. The device includes a flexible, pressure resistant enclosure having a size less than approximately 2 feet by 3 feet and having a biased configuration that is substantially flat, the enclosure having an upper side for contacting a tire, and a lower side for being positioned at a ground surface. The enclosure has opposing ends that are sealed to contain an interior pressure of up to 50 psi. The sealed opposing ends and the enclosure are structured to support wheel contact at its upper surface without damaging the pressure resistant enclosure. The device further includes an air valve coupled to the enclosure for supplying and releasing air to the enclosure to facilitate raising and lowering the recreational vehicle to a level configuration.

As another example, the invention can be described as a device for leveling a recreational vehicle, comprising an inflatable air bag, configured to contain a volume of pressurized air, having a size suitable for supporting a tire of a recreational vehicle, and configured to be disposed between a ground surface and the tire of the recreational vehicle. The air bag includes a one-way air valve, in fluid communication with an interior of the air bag, configured for allowing pressurized air into and out of the air bag, to lift the tire of the recreational vehicle so as to facilitate bringing the vehicle to a level configuration.

As another example, the invention can be described as a system for leveling a recreational vehicle. The system includes a segment of high strength flexible hose, an air valve, and an adjustable jack stand. The segment of hose is sealed at apposing ends, defining an enclosure capable of containing a volume of pressurized air, the enclosure having a size suitable for supporting a wheel of a recreational vehicle. The segment is configured to be disposed between a ground surface and the wheel of the recreational vehicle. The air valve is disposed in a wall of the segment of flexible hose, and is configured for allowing air into and out of the hose. The air valve allows air of a desired pressure to be pumped into the hose to lift the wheel of the recreational vehicle so as to facilitate bringing the vehicle to a level configuration. The jack stand is configured to be disposed below the recreational vehicle on a side near the inflated hose, so as to support the vehicle in a level configuration in case of undesired deflation of the hose segment.

As yet another example, the invention can be described as a method for leveling a recreational vehicle parked on a sloped site. The method includes the steps of (a) identifying a wheel of the recreational vehicle on a low side of the vehicle; (b) placing an uninflated air bag on the ground near a tire of the vehicle on the low side; (c) maneuvering the tire of the recreational vehicle to a position atop the uninflated air bag; and (d) inflating the air bag so as to raise the low side of the vehicle.

It is to be understood that the above-referenced arrangements are illustrative of the application of the principles of the present invention. Numerous modifications and alternative arrangements can be devised without departing from the spirit and scope of the present invention. While the invention has been shown in the drawings and described above in connection with exemplary embodiments(s) thereof, it will be apparent to those of ordinary skill in the art that numerous modifications can be made without departing from the principles and concepts of the invention as set forth and as claimed in a later non-provisional patent application.

What is claimed is:

1. A system for leveling a recreational vehicle, comprising:
a. an inflatable air bag, configured to contain a volume of pressurized air, having a size suitable for supporting a tire of a recreational vehicle, and configured to be disposed between a ground surface and the tire of the recreational vehicle; and
b. a one-way air valve, in fluid communication with an interior of the air bag, configured for allowing pressurized air into and out of the air bag, to lift the tire of the recreational vehicle so as to facilitate bringing the vehicle to a level configuration.

2. A system in accordance with claim 1, wherein the inflatable air bag is less than about 2 feet wide and less than about 3 feet long when uninflated.

3. A system in accordance with claim 2, wherein the air bag is about 13 inches wide and 22 inches long when uninflated.

4. A system in accordance with claim 1, wherein the air bag comprises a section of high strength flexible hose, sealed at apposing ends to form an air-tight enclosure.

5. A system in accordance with claim 1, wherein the air bag is configured to contain a maximum working pressure of at least about 50 psi

6. A system in accordance with claim 1, further comprising a pressure relief valve, configured to automatically release air from the air bag if pressure within the bag exceeds a maximum working pressure.

7. A system in accordance with claim 1, wherein the air bag is configured to lift the tire of the recreational vehicle by up to at least 5 inches when fully inflated.

8. A system in accordance with claim 1, further comprising a pump for pumping air into the air bag through the one-way air valve.

9. A system in accordance with claim 8, wherein the pump is selected from the group consisting of a hand pump, a foot pump, and an air compressor.

10. A system in accordance with claim 1, wherein the inflatable air bag comprises two inflatable air bags, each of the two air bags being configured for placement beneath each of a pair of tandem wheels of the recreational vehicle.

11. A system in accordance with claim 10, wherein the two air bags are interconnected so as to be in fluid communication with each other, such that inflation of one bag will substantially simultaneously inflate the other bag, and such that pressure within the two bags will be substantially equalized.

12. A system in accordance with claim 1, further comprising an adjustable support, configured to be disposed below the recreational vehicle on a side near the air bag when inflated, so as to support the recreational vehicle in a level configuration in case of unintended deflation of the air bag.

13. A device for lifting a tire of a recreational vehicle to a desired elevation for leveling purposes, comprising:
a. a flexible, pressure resistant enclosure having a size less than approximately 2 feet by 3 feet and having a biased configuration that is substantially flat, said enclosure having an upper side for contacting a tire, and a lower side for being positioned at a ground surface;
b. said enclosure having opposing ends that are sealed to contain an interior pressure of up to 50 psi;
c. the sealed opposing ends and the enclosure being configured to support wheel contact at its upper surface without damaging the pressure resistant enclosure; and
d. an air valve coupled to the enclosure for supplying and releasing air to the enclosure to facilitate raising and lowering the recreational vehicle to a level configuration.

14. A device in accordance with claim 12, further comprising a pressure relief valve, configured to automatically release air from the air bag if pressure within the bag exceeds a maximum working pressure.

15. A device in accordance with claim 12, wherein the air bag is about 13 inches wide and 22 inches long when uninflated.

16. A device in accordance with claim 12, wherein the air bag is configured to lift the tire of the recreational vehicle by up to at least 5 inches when fully inflated.

17. A device in accordance with claim 12, further comprising a pump for pumping air into the air bag through the one-way air valve.

18. A device in accordance with claim 12, wherein the pump is selected from the group consisting of a hand pump, a foot pump, and an air compressor.

19. A device in accordance with claim 12, wherein the inflatable air bag comprises two inflatable air bags, each of the two air bags being configured for placement beneath each of a pair of tandem wheels of the recreational vehicle.

20. A device in accordance with claim 12, wherein the two air bags are interconnected so as to be in fluid communication with each other, such that inflation of one bag will substantially simultaneously inflate the other bag, and such that pressure within the two bags will be substantially equalized.

21. A system for leveling a recreational vehicle, comprising:
a. a segment of high strength flexible hose, sealed at apposing ends, defining an enclosure capable of containing a volume of pressurized air, the enclosure having a size suitable for supporting a wheel of a recreational vehicle, and configured to be disposed between a ground surface and the wheel of the recreational vehicle;
b. an air valve, disposed in a wall of the segment of flexible hose, configured for allowing air into and out of the hose, such that air of a desired pressure may be pumped into the hose to lift the wheel of the recreational vehicle so as to facilitate bringing the vehicle to a level configuration; and
c. an adjustable support, configured to be disposed below the recreational vehicle on a side near the hose when inflated, so as to support the vehicle in a level configuration in case of undesired deflation of the hose segment.

22. A method for leveling a recreational vehicle parked on a sloped site, comprising the steps of:
a. identifying a wheel of the recreational vehicle on a low side of the vehicle;
b. placing an uninflated air bag on ground near a tire of the vehicle on the low side;
c. maneuvering the tire of the recreational vehicle to a position atop the uninflated air bag; and
d. inflating the air bag so as to raise the low side of the vehicle to make the vehicle substantially level.

23. A method in accordance with claim 22, further comprising the step of placing an adjustable support below a portion of the recreational vehicle on a side near the air bag, so as to support the vehicle in a substantially level configuration in case of undesired deflation of the air bag.
